(19) United States
(12) Patent Application Publication
(10) Pub. No.: US 2026/0103940 A1
(43) Pub. Date: Apr. 16, 2026

(54) DOOR OPEN-CLOSE DEVICE FOR VEHICLE

(71) Applicants: Hyundai Motor Company, Seoul (KR); Kia Corporation, Seoul (KR); KWANGJIN CO., LTD., Asan-si (KR)

(72) Inventors: Jaeseung LEE, Hwaseong-SI (KR); Gookhyun JEON, Hwaseong-Si (KR); Jin-Su JANG, Asan-SI (KR); Tae-Yong JEON, Asan-Si (KR); Pil-Seong JEON, Asan-Si (KR); Jun-Yeong BAE, Asan-Si (KR)

(73) Assignees: Hyundai Motor Company, Seoul (KR); Kia Corporation, Seoul (KR); KWANGJIN CO., LTD., Asan-si (KR)

(21) Appl. No.: 19/247,278

(22) Filed: Jun. 24, 2025

(30) Foreign Application Priority Data
Oct. 16, 2024 (KR) 10-2024-0141355

(51) Int. Cl. E05F 15/63; E05D 15/30

(52) U.S. Cl. CPC E05F 15/63; E05D 15/30; E05F 2015/631; E05Y 2201/652; E05Y 2201/668; E05Y 2201/716; E05Y 2201/722; E05Y 2900/531

(57) ABSTRACT

A door open-close device for a vehicle includes a variable arm motor fixedly disposed on the side of the vehicle body and to provide power to operate the door, a first variable arm assembly having a first side hingedly coupled to the variable arm motor and a second side hingedly coupled to the side of the door and configured to transmit a rotational force to the door by driving the variable arm motor, and a second variable arm assembly disposed to be parallel to the first variable arm assembly in a longitudinal direction of the vehicle body, and having a first side hingedly coupled to the side of the vehicle body and a second side hingedly coupled to the side of the door, configured to interact with a pivotal rotation of the first variable arm assembly, and transmit the rotational force to the door.

### CROSS-REFERENCE TO RELATED APPLICATION

The present application claims priority to Korean Patent Application No. 10-2024-0141355 filed with the Korean Intellectual Property Office on Oct. 16, 2024, the entire contents of which is incorporated herein for all purposes by this reference.

### BACKGROUND OF THE INVENTION

### Field of the Invention

The present disclosure relates to a door open-close device for a vehicle, and more particularly, to a bi-directional door open-close device for a vehicle configured to open and close a door opening portion of a vehicle body by sliding and popping up a door of the vehicle in both front and rear directions, in the vehicle without a B-pillar.

### Description of Related Art

In general, doors for a vehicle are doors that separate the interior and exterior of the vehicle, and serve an important function of protecting passengers safely by blocking external noise, rain, dust, and wind, etc. and absorbing an impact along with a side structure in case of a side collision.

There are various types of doors for the vehicle, including doors for special purposes, but hinged swing doors are most often applied to passenger vehicles.

Usually, a swing door refers to a door that opens to the outside of a vehicle body around a hinge shaft disposed through a hinge bracket between the vehicle body and the swing door, and has the advantage of being easy to open and close, and easy to maintain and repair due to a simple structure.

On the other hand, a counter-swing door that has a high sense of openness when a door is opened, and is advantageous for passengers to get on and off is applied to some vehicles. The counter-swing door is opened and closed by using the rotation of an arm connected to the vehicle body and the door.

However, the counter swing door has the advantage of having a large amount of door opening and closing, but there is a problem of an excessive amount of protrusion to the outside of the vehicle when the door is opened due to a length of the arm. In addition, as shown in FIG. 1, during the opening of the door, when front and rear door arms 4 and 5 having one end coupled to a vehicle body 1 and the other ends respectively coupled to front and rear doors 2 and 3 are rotated, due to lengths of the door arms 4 and 5, an amount of protrusion of the doors 2 and 3 to the outside of the vehicle is excessive, and there is a risk of colliding with an external obstacle. To this end, it is necessary to perform operations such as stop/reverse after collision.

### BRIEF SUMMARY

The present disclosure attempts to provide a door open-close device for a vehicle capable of improving operability, performance, and stability by applying a link of a variable length to a door, in a counter sliding door structure of the vehicle without a B-pillar.

A door open-close device for a vehicle configured to open and close a door opening portion by sliding and popping up a door disposed in a vehicle body according to an embodiment of the present disclosure includes a variable arm motor fixedly disposed on a side of the vehicle body and configured to provide a driving power to operate the door, a first variable arm assembly having a first side hingedly coupled to the variable arm motor and a second side hingedly coupled to the side of the door and configured to transmit a rotational force to the door by driving the variable arm motor, and a second variable arm assembly disposed to be parallel to the first variable arm assembly in a longitudinal direction of the vehicle body, and having a first side hingedly coupled to the side of the vehicle body and a second side hingedly coupled to the side of the door, configured to interact with a pivotal rotation of the first variable arm assembly, and transmit the rotational force to the door.

The first variable arm assembly may include a drive gear engaged with a variable arm motor gear disposed in a rotation shaft of the variable arm motor and rotated, a first arm pulley gear engaged with the drive gear and rotated, a first hook arm coupled to a central axis of the first arm pulley gear and rotated together with the first arm pulley gear, a first guide bearing disposed in an end portion of the first hook arm, configured to guide a pivotal rotation of the first hook arm, and roll and move to limit a rotation angle of the first arm pulley gear, a first rotation arm hingedly connected to the vehicle body and connected to a central axis of the first arm pulley gear and rotated together with a rotation of the first arm pulley gear, a first slide arm having one end connected to the first guide bearing so that the first guide bearing rotates, and disposed inside the first rotation arm to linearly move in a longitudinal direction of the first rotation arm, and a first rack gear arm gear-engaged to the first slide arm, configured to linearly move together with the first slide arm according to a linear movement of the first slide arm, and having one end hingedly connected to the side of the door.

The first guide bearing may be disposed in a slot formed in a lower portion of the end portion of the first hook arm.

A first pinion gear may be disposed in a center of the first slide arm, a first rotation arm rack gear engaged with the first pinion gear in a first side thereof may be disposed in the first rotation arm, and the first pinion gear may rotate according to a rotation of the first rotation arm and the first slide arm may linearly move.

A rack gear engaged with a second side of the first pinion gear may be disposed in a center of the first rack gear arm, and as the first pinion gear rotates according to a linear movement of the first slide arm, the first rack gear arm may linearly move.

The second variable arm assembly may include a second arm pulley gear engaged to the first arm pulley gear by a timing belt and configured to interact with and be rotated together with the first arm pulley gear, a second hook arm coupled to a central axis of the second arm pulley gear and rotated together with the second arm pulley gear, a second guide bearing disposed in an end portion of the second hook arm, configured to guide a pivotal rotation of the second hook arm, and roll and move to limit a rotation angle of the second arm pulley gear, a second rotation arm connected to the central axis of the second arm pulley gear and rotated together with a rotation of the second arm pulley gear, a second slide arm having one end connected to the second guide bearing, and disposed inside the second rotation arm to linearly move in a longitudinal direction of the second rotation arm, and a second rack gear arm gear-engaged to the second slide arm, configured to linearly move together according to a linear movement of the second slide arm, and having one end hingedly connected to the side of the door.

The second guide bearing may be disposed in a slot formed in a lower portion of the end portion of the second hook arm.

A second pinion gear may be disposed in a center of the second slide arm, a second rotation arm rack gear engaged with the second pinion gear in a first side thereof may be disposed in the second rotation arm, and the second pinion gear may rotate according to a rotation of the second rotation arm and the second slide arm may linearly move.

A rack gear engaged with a second side of the second pinion gear may be disposed in a center of the second rack gear arm, and as the second pinion gear rotates according to a linear movement of the second slide arm, the second rack gear arm may linearly move.

A base plate may be disposed on the side of the vehicle body, in which the variable arm motor is fixedly disposed, and to which one ends of the first variable arm assembly and the second variable arm assembly are hingedly coupled.

A first guide slit and a second guide slit may be formed in the base plate, the first guide slit providing a path varying a relative length of the first rotation arm, the first slide arm, and the first rack gear arm while the first guide bearing is inserted and rotated, and the second guide slit providing a path varying relative lengths of the second rotation arm, the second slide arm, and the second rack gear arm while the second guide bearing is inserted and rotated.

The first guide slit and the second guide slit may be formed in a convex and symmetrical shape toward the side of the door.

Inside the door, a door bracket may be disposed to hingedly couple one end of the first rack gear arm to one end of the second rack gear arm and connect the first variable arm assembly and the second variable arm assembly to the door.

When the door starts to be opened, the variable arm motor may be driven to allow a first side of the first variable arm assembly to rotate, and lengths of the first variable arm assembly and the second variable arm assembly may be changed to be gradually shortened.

In a state in which the door protrudes to a maximum with respect to the vehicle body while the door is opened, the lengths of the first variable arm assembly and the second variable arm assembly may be changed to be the minimum.

Until the door is completely opened in the state in which the door protrudes to the maximum with respect to the vehicle body, the lengths of the first variable arm assembly and the second variable arm assembly may be gradually increased and changed to be the maximum.

The variable arm motor may be set to stop driving when the door is completely opened.

The variable arm motor may have a preset number of rotations to adjust a movement range of each of the first variable arm assembly and the second variable arm assembly and an amount of opening of the door according to the number of rotations.

According to an embodiment of the present disclosure, the variable door arm structure is applied in the counter sliding door structure of the vehicle without a B-pillar, and thus, the door rotation radius may minimized, thereby minimizing the amount of protrusion toward the outside of the vehicle body of the door when the door is opened.

In addition, a center rail structure is deleted, and thus, the door opening width may be maximized, and cost reduction, assembly, and maintenance may be improved due to the simplification of the structure which allows more than two or more swing and sliding trajectories to be implemented in a single module.

### BRIEF DESCRIPTION OF THE DRAWINGS

FIG. 1 is a diagram schematically illustrating an opening operation process of the fixing link swing type door of the related art.

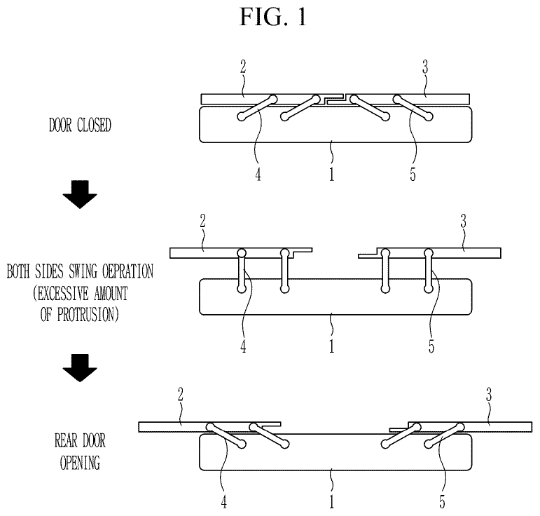

FIG. 2 is a diagram schematically illustrating a state in which a door open-close device for a vehicle according to an embodiment of the present disclosure is applied to the vehicle.

FIG. 3 is a diagram schematically illustrating the door open-close device for the vehicle according to an embodiment of the present disclosure.

FIG. 4 is an exploded perspective view of the door open-close device for the vehicle according to an embodiment of the present disclosure.

FIG. 5 is a diagram schematically illustrating a door closing state of the door open-close device for the vehicle according to an embodiment of the present disclosure viewed from above.

FIG. 6 is a diagram schematically illustrating a state, viewed from above, in which a door of the door open-close device for the vehicle according to an embodiment of the present disclosure is opening.

FIG. 7 is a diagram schematically illustrating a door opening completion state of the door open-close device for the vehicle according to an embodiment of the present disclosure viewed from above.

FIG. 8 is a diagram illustrating a connection relationship between a variable arm motor and a drive gear of the door open-close device for the vehicle according to an embodiment of the present disclosure.

FIG. 9 is a diagram illustrating a connection relationship between a first arm pulley gear and a second arm pulley gear of the door open-close device for the vehicle according to an embodiment of the present disclosure.

FIG. 10 is a diagram illustrating a part of a first variable arm assembly of the door open-close device for the vehicle according to an embodiment of the present disclosure.

FIG. 11 is a diagram illustrating a movement of a guide bearing in a guide slit of the door open-close device for the vehicle according to an embodiment of the present disclosure.

FIG. 12 is a diagram illustrating an angle change of a variable arm assembly of the door open-close device for the vehicle according to an embodiment of the present disclosure.

FIG. 13 is a cross-sectional view of the variable arm assembly of the door open-close device for the vehicle according to an embodiment of the present disclosure.

FIG. 14 is a diagram illustrating a movement of a slide arm according to a movement of the guide bearing of the variable arm assembly of the door open-close device for the vehicle according to an embodiment of the present disclosure.

FIG. 15 is a diagram illustrating a linear movement of the slide arm by engaging a pinion gear of the slide arm and a rack gear of a rotation arm of the variable arm assembly of the door open-close device for the vehicle according to an embodiment of the present disclosure.

FIG. 16 is a diagram illustrating a linear movement of a rack gear arm by engaging the pinion gear of the slide arm and a rack gear of the rack gear arm of the variable arm assembly of the door open-close device for the vehicle according to an embodiment of the present disclosure.

FIG. 17 is a diagram illustrating a length change according to a position of the guide bearing of the variable arm assembly of the door open-close device for the vehicle according to an embodiment of the present disclosure.

### DETAILED DESCRIPTION

The present disclosure will be described more fully hereinafter with reference to the accompanying drawings, so that those skilled in the art to which the present disclosure pertains may easily implement the embodiments of the present disclosure. However, the present disclosure may be implemented in many different forms and is not limited to the embodiments described herein.

In addition, in various embodiments, elements having the same configuration are typically described in an embodiment by using the same reference numerals, and in other embodiments, only configurations different from an embodiment will be described.

Please be informed that the drawings are schematic and not drawn to scale. Relative dimensions and ratios of parts in the drawings are shown exaggerated or reduced in size for clarity and convenience in the drawings, and any dimensions are illustrative only and not limiting. In addition, the same reference numerals are used to denote similar features in the same structure, element or parts appearing in two or more drawings. When an element is referred to as being “on” another element, it may be directly on the other element or intervening elements may also be accompanied.

The embodiment of the present disclosure specifically represents an embodiment of the present disclosure. As a result, various modifications of diagrams are expected. Therefore, the embodiment is not limited to a specific shape of an area shown, and includes, for example, a modification of the shape by manufacturing.

Hereinafter, a door open-close device for a vehicle according to an embodiment of the present disclosure will be described in detail with reference to the accompanying drawings.

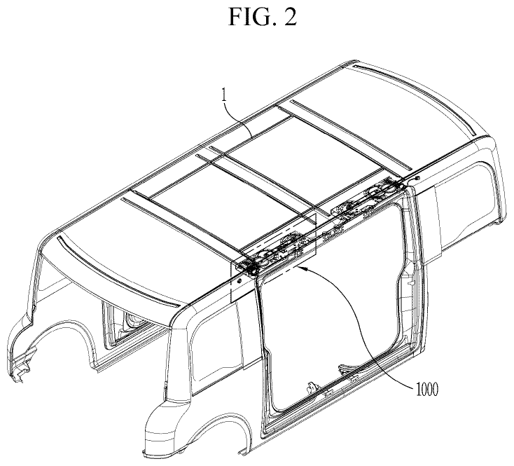

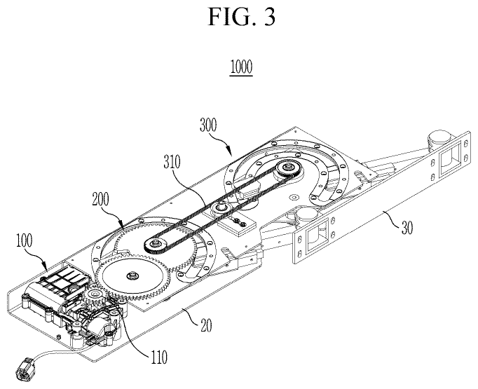

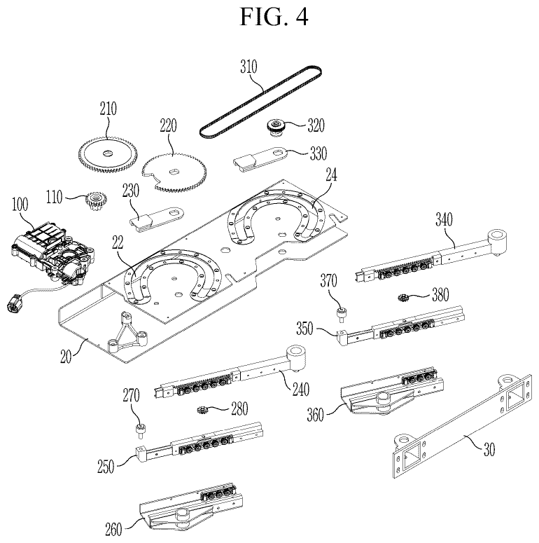

FIG. 2 is a diagram schematically illustrating a state in which a door open-close device for a vehicle according to an embodiment of the present disclosure is applied to the vehicle. FIG. 3 is a diagram schematically illustrating the door open-close device for the vehicle according to an embodiment of the present disclosure. FIG. 4 is an exploded perspective view of the door open-close device for the vehicle according to an embodiment of the present disclosure.

Referring to FIG. 2, a door open-close device 1000 for a vehicle according to an embodiment of the present disclosure is to open and close a door opening portion by sliding and popping up front and rear doors 10 formed on a vehicle body 1 and is disposed in an upper portion of the door opening portion of the vehicle body 1.

The door open-close device 1000 may be disposed in a pair to face each other on the upper portion of the door opening portion corresponding to the front and rear doors 10, respectively, and may be disposed to connect the outside of the vehicle body 1 and the inside of the front and rear doors 10.

Referring to FIGS. 3 and 4, the vehicle door open-close device 1000 according to an embodiment of the present disclosure includes a variable arm motor 100, a first variable arm assembly 200, and a second variable arm assembly 300.

The variable arm motor 100 may be fixedly disposed on the side of the vehicle body 1 and may provide power to operate the door 10. The variable arm motor 100 generates a driving force and transmits the driving force to the first variable arm assembly 200. The first variable arm assembly 200 has a first side hingedly coupled to the variable arm motor 100 and a second side hingedly coupled to the side of the door 10 so that the first variable arm assembly 200 transmits a rotational force to the door 10 by driving the variable arm motor 100.

The second variable arm assembly 300 is disposed to be parallel to the first variable arm assembly 200 in a longitudinal direction of the vehicle body 1, and has a first side hingedly coupled to the side of the vehicle body 1 and a second side hingedly coupled to the side of the door 10. The second variable arm assembly 300 interacts with the first variable arm assembly 200 that is hinge-rotated by the driving of the variable arm motor 100 and hinge-rotated, and transmits a rotational force to the door 10.

The first variable arm assembly 200 and the second variable arm assembly 300 may be connected to each other by a timing belt 310 and interact with each other.

The variable arm motor 100 may have a preset number of rotations to adjust a movement range of each of the first variable arm assembly 200 and the second variable arm assembly 300 and an amount of opening of the door 10 according to the number of rotations.

As shown in FIG. 4, the first variable arm assembly 200 may include a drive gear 210, a first arm pulley gear 220, a first hook arm 230, a first guide bearing 270, a first rotation arm 260, a first slide arm 250, and a first rack gear arm 240.

The first variable arm assembly 200 may be disposed on a base plate 20 disposed on the side of the vehicle body 1. The base plate 20 may have a box shape with one surface open, the drive gear 210, the first arm pulley gear 220, and the first hook arm 230 may be disposed on an upper surface of the base plate 20, and the first rotation arm 260, the first slide arm 250, and the first rack gear arm 240 may be disposed inside the base plate 20. The first guide bearing 270 may penetrate the base plate 20 to connect the first hook arm 230 and the first slide arm 250 to each other.

The drive gear 210 may be engaged with a variable arm motor gear 110 formed in a rotation shaft of the variable arm motor 100 and rotated together with the variable arm motor gear 110 when the variable arm motor 100 is driven.

The first arm pulley gear 220 may be engaged with the driver gear 210 and rotated. The driver gear 210 may include two overlapping gears having different radii, an upper gear having a large radius may be engaged with the variable arm motor gear 110, and a lower gear having a small radius may be engaged with the first arm pulley gear 220.

The first hook arm 230 may be coupled to a central axis of the first arm pulley gear 220 and rotated together with the first arm pulley gear 220. The first hook arm 230 may have an end portion inserted into and fixed to a groove formed in a first side of the first arm pulley gear 220, and have a slot formed in a lower portion thereof. The first guide bearing 270 may be rotatably inserted into a slot formed in the end portion of the first hook arm 230.

The first guide bearing 270 may guide a pivotal rotation of the first hook arm 230 and may roll and move to limit a rotation angle of the first arm pulley gear 220.

The first rotation arm 260 may be connected to the central axis of the first arm pulley gear 220 and rotated together with the rotation of the first arm pulley gear 220.

The first slide arm 250 may have one end connected to the first guide bearing 270 so that the first guide bearing 270 rotates, and may be disposed inside the first rotation arm 260 to linearly move in a longitudinal direction of the first rotation arm 260.

The first rack gear arm 240 is gear-engaged to the first slide arm 250, linearly moves together with the first slide arm 250 as the first slide arm 250 linearly moves, resulting in the first variable arm assembly 200 being expanded or contracted, and has one end connected to the side of the door 10.

The second variable arm assembly 300 may include a second arm pulley gear 320, a second hook arm 330, a second guide bearing 370, a second rotation arm 360, a second slide arm 350, and a second rack gear arm 340.

The second variable arm assembly 300 may be disposed parallel to the first variable arm assembly 200 in the longitudinal direction of the vehicle body 1, and may be disposed on the base plate 20, like the first variable arm assembly 200. The second arm pulley gear 320 and the second hook arm 330 may be disposed on an upper surface of the base plate 20, and the second rotation arm 360, the second slide arm 350, and the second rack gear arm 340 may be disposed inside the base plate 20. The second guide bearing 370 may penetrate the base plate 20 to connect the second hook arm 330 and the second slide arm 350 to each other.

The second arm pulley gear 320 may be connected to the first arm pulley gear 220 by the timing belt 310 and interact with and be rotated together with the first arm pulley gear 220.

The second hook arm 330 may be coupled to a central axis of the second arm pulley gear 320 and rotated together with the second arm pulley gear 320. The second hook arm 330 may have an end portion inserted into and fixed to a groove formed in a first side of the second arm pulley gear 320, and have a slot formed in a lower portion thereof. The second guide bearing 370 may be rotatably inserted into a slot formed in the end portion of the second hook arm 330.

The second guide bearing 370 may guide a pivotal rotation of the second hook arm 330 and may roll and move to limit a rotation angle of the second arm pulley gear 320.

The second rotation arm 360 may be connected to the central axis of the second arm pulley gear 320 and rotated together with the rotation of the second arm pulley gear 320.

The second slide arm 350 may have one end connected to the second guide bearing 370 so that the second guide bearing 370 rotates, and may be disposed inside the second rotation arm 360 to linearly move in a longitudinal direction of the second rotation arm 360.

The second rack gear arm 340 is gear-engaged to the second slide arm 350 and linearly moves together as the second slide arm 350 linearly moves, resulting in the second variable arm assembly 300 being expanded or contracted, and has one end connected to the side of the door 10.

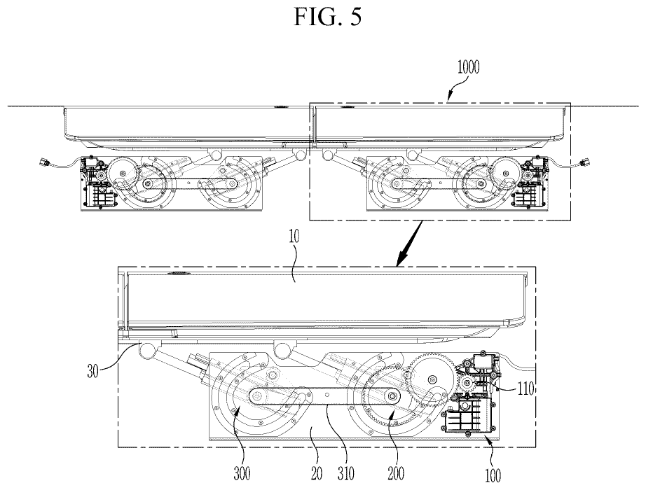

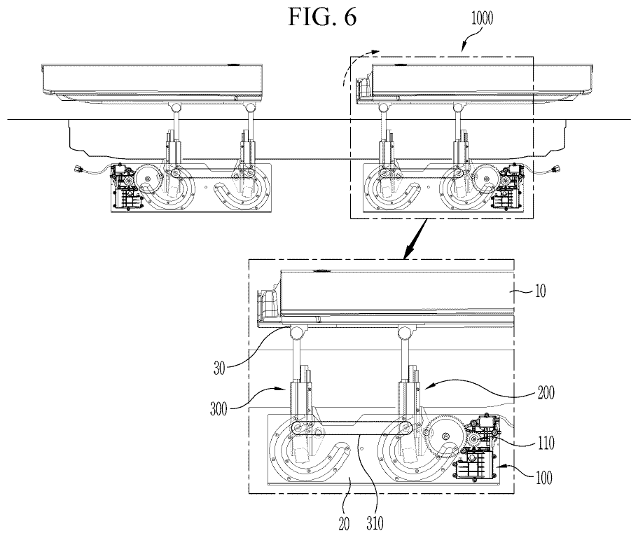

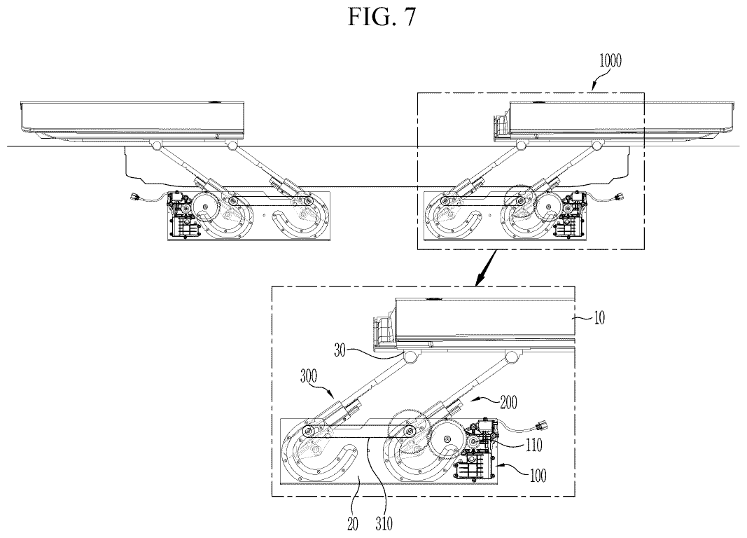

FIG. 5 is a diagram schematically illustrating a door closing state of the door open-close device for the vehicle according to an embodiment of the present disclosure viewed from above. FIG. 6 is a diagram schematically illustrating a state, viewed from above, in which a door of the door open-close device for the vehicle according to an embodiment of the present disclosure is opening. FIG. 7 is a diagram schematically illustrating a door opening completion state of the door open-close device for the vehicle according to an embodiment of the present disclosure viewed from above.

Referring to FIG. 5, in a state in which the door 10 is closed, the door 10 is disposed parallel to the vehicle body 1, a central axis of the drive gear 210, the first arm pulley gear 220, and a hinge 262 of the first rotation arm 260 of the first variable arm assembly 200 is rotatably connected to the base plate 20, and one end of the first rack gear arm 240 of the first variable arm assembly 200 is rotatably connected to a door bracket 30 on the side of the door 10. In addition, the first slide arm 250 is slid and movably connected to the first rack gear arm 240 via the first guide bearing 270, the first hook arm 230, and the first arm pulley gear 220. At this time, the variable arm motor 100 is not driven.

In addition, the second variable arm assembly 300 is connected to and interacts with the first variable arm assembly 200 by the timing belt 310, a central axis of the second arm pulley gear 320 and the second rotation arm 360 is rotatably connected to the base plate 20, and one end of the second rack gear arm 340 of the second variable arm assembly 300 is rotatably connected to the door bracket 30 on the side of the door 10. In addition, the second slide arm 350 is slid and movably connected to the second rack gear arm 340 via the second guide bearing 370, the second hook arm 330, and the second arm pulley gear 320.

Referring to FIG. 6, in a state in which the door 10 starts to be opened, when the variable arm motor 100 is driven and the first variable arm assembly 200 starts to turn toward the outside of the vehicle body 1, a part of the door bracket 30 connected to a second side of the first variable arm assembly 200 starts to move toward the outside of the vehicle body 1.

The second variable arm assembly 300 interacts with the first variable arm assembly 200 and turns, and, in a state in which the door bracket 30 and the door 10 are disposed parallel to the vehicle body 1, starts to turn toward the outside of the vehicle body 1.

When the first rotation arm 260, the first slide arm 250, and the first rack gear arm 240 of the first variable arm assembly 200, and the second rotation arm 360, the second slide arm 350, and the second rack gear arm 340 of the second variable arm assembly 300 are disposed to extend in a direction perpendicular to the vehicle body 1, a coupling length of the first slide arm 250 and the first rack gear arm 240 and a coupling length of the second slide arm 350 and the second rack gear arm 340 may be the minimum, and thus an amount of protrusion of the door 10 to the outside of the vehicle body 1 may be minimized.

Referring to FIG. 7, the variable arm motor 100 is driven to rotate the first variable arm assembly 200 and the second variable arm assembly 300 until opening of the door 10 is completed, and in this process, the first slide arm 250 and the second slide arm 350 respectively move relative to each other by gear coupling between the first rack gear arm 240 and the second rack gear arm 340.

In a state in which the door 10 is opened to the maximum, the coupling length of the first slide arm 250 and the first rack gear arm 240 and the coupling length of the second slide arm 350 and the second rack gear arm 340 may be the maximum, and a state in which the amount of protrusion of the door 10 to the outside of the vehicle body 1 is minimized may be maintained.

The process of changing from a complete opening state to a complete closing state of the door 10 may be a reverse order of the process of FIGS. 5 to 7.

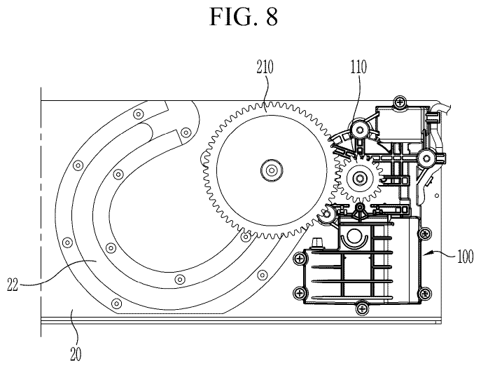

FIG. 8 is a diagram illustrating a connection relationship between a variable arm motor and a drive gear of the door open-close device for the vehicle according to an embodiment of the present disclosure.

Referring to FIG. 8, the variable arm motor gear 110 is disposed on a rotation shaft of the variable arm motor 100, and the driver gear 210 is engaged with the variable arm motor gear 110. The driver gear 210 may include two overlapping gears having different radii, the variable arm motor gear 110 may be engaged with an upper gear having a large radius, and a lower gear having a small radius may be engaged with the first arm pulley gear 220.

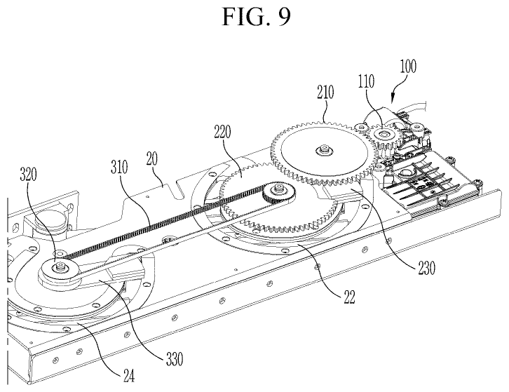

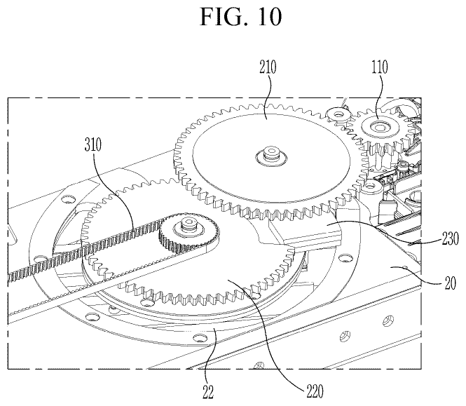

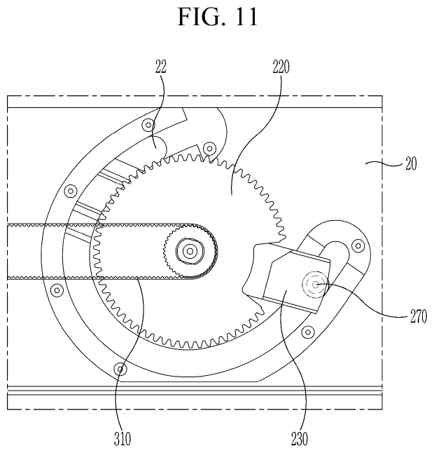

FIG. 9 is a diagram illustrating a connection relationship between a first arm pulley gear and a second arm pulley gear of the door open-close device for the vehicle according to an embodiment of the present disclosure. FIG. 10 is a diagram illustrating a part of a first variable arm assembly of the door open-close device for the vehicle according to an embodiment of the present disclosure. FIG. 11 is a diagram illustrating a movement of a guide bearing in a guide slit of the door open-close device for the vehicle according to an embodiment of the present disclosure.

Referring to FIGS. 9 to 11, the first hook arm 230 is coaxially coupled to the first arm pulley gear 220 engaged with a lower gear with a small radius of the driver gear 210, and the first guide bearing 270 inserted into an end portion of the first hook arm 230 is inserted into a first guide slit 22 and rotated. A movement range of the end portion of the first hook arm 230 may be limited by the first guide slit 22.

Like the driver gear 210, the first arm pulley gear 220 may include two overlapping gears having different radii, the driver gear 210 may be engaged with a lower gear having a large radius, and the timing belt 310 may be engaged with an upper gear having a small radius. The timing belt 310 may be connected to the second arm pulley gear 320 so that the second arm pulley gear 320 may interact with the rotation of the first arm pulley gear 220 and be rotated together with the first arm pulley gear 220.

The second hook arm 330 is coaxially coupled to the second arm pulley gear 320, and the second guide bearing 370 inserted into an end portion of the second hook arm 330 is inserted into a second guide slit 24 and rotated. A movement range of the end portion of the second hook arm 330 may be limited by the second guide slit 24.

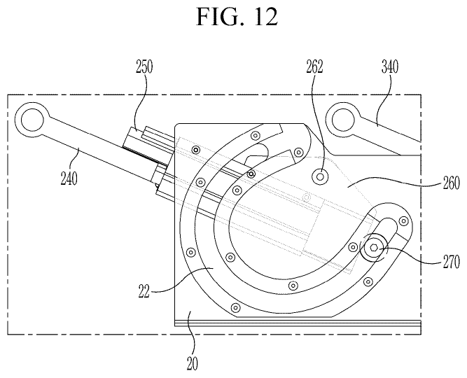

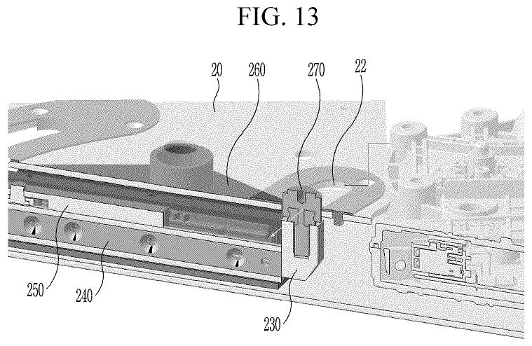

FIG. 12 is a diagram illustrating an angle change of a variable arm assembly of the door open-close device for the vehicle according to an embodiment of the present disclosure. FIG. 13 is a cross-sectional view of the variable arm assembly of the door open-close device for the vehicle according to an embodiment of the present disclosure.

Referring to FIGS. 12 and 13, the first guide bearing 270 is rotatably connected to one end of the first slide arm 250 and moves along a path within the first guide slit 22. As the first guide bearing 270 moves within the first guide slit 22, one end of the first slide arm 250 turns with respect to the hinge 262 of the first rotation arm 260, and the first rack gear arm 240 gear-engaged to the first slide arm 250 turns together. Because one end of the first rack gear arm 240 is connected to the side of the door 10, the door 10 turns when the first rack gear arm 240 turns.

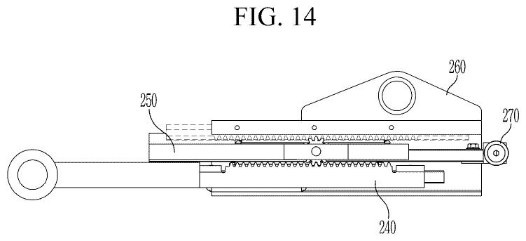

FIG. 14 is a diagram illustrating a movement of a slide arm according to a movement of the guide bearing of the variable arm assembly of the door open-close device for the vehicle according to an embodiment of the present disclosure.

As shown in FIG. 14, when the first guide bearing 270 moves along the first guide slit 22, one end of the first slide arm 250 connected to the first guide bearing 270 turns along the first guide slit 22. Likewise, when the second guide bearing 370 moves along the second guide slit 24, one end of the second slide arm 350 connected to the second guide bearing 370 turns along the second guide slit 24.

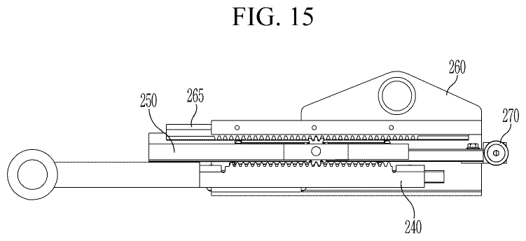

FIG. 15 is a diagram illustrating a linear movement of the slide arm by engaging a pinion gear of the slide arm and a rack gear of a rotation arm of the variable arm assembly of the door open-close device for the vehicle according to an embodiment of the present disclosure.

As shown in FIG. 15, a first pinion gear 280 is disposed in the center of the first slide arm 250, and a first rotation arm rack gear 265 engaged with the first pinion gear 280 in a first side thereof is disposed in the first rotation arm 260. The first pinion gear 280 may rotate according to the rotation of the first rotation arm 260 and the first slide arm 250 may turn and linearly move. By such a structure, while the first rotation arm 260 rotates only without a linear movement, the first slide arm 250 may move relatively linearly with respect to the first rotation arm 260.

Likewise, a second pinion gear 380 is disposed in the center of the second slide arm 350, and a second rotation arm rack gear engaged with the second pinion gear 380 in a first side thereof is disposed in the second rotation arm 360, such that the second pinion gear 380 may rotate according to the rotation of the second rotation arm 360 and the second slide arm 350 may turn and linearly move. At this time, the second rotation arm 360 may only rotate without a linear movement, and the second slide arm 350 may move relatively linearly with respect to the second rotation arm 360.

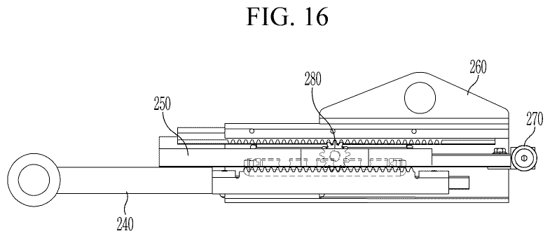

FIG. 16 is a diagram illustrating a linear movement of a rack gear arm by engaging the pinion gear of the slide arm and a rack gear of the rack gear arm of the variable arm assembly of the door open-close device for the vehicle according to an embodiment of the present disclosure.

As shown in FIG. 16, the rack gear engaged with a second side of the first pinion gear 280 is disposed in the center of the first rack gear arm 240. As the first pinion gear 280 rotates and is engaged with the rack gear according to a linear movement of the first slide arm 250, the first rack gear arm 240 may linearly move with respect to the first slide arm 250.

Likewise, the rack gear engaged with a second side of the second pinion gear 280 is disposed in the center of the second rack gear arm 340, and the second linear gear 380 rotates according to a linear movement of the second slide arm 350 so that the second rack gear arm 340 may linearly move with respect to the second slide arm 350.

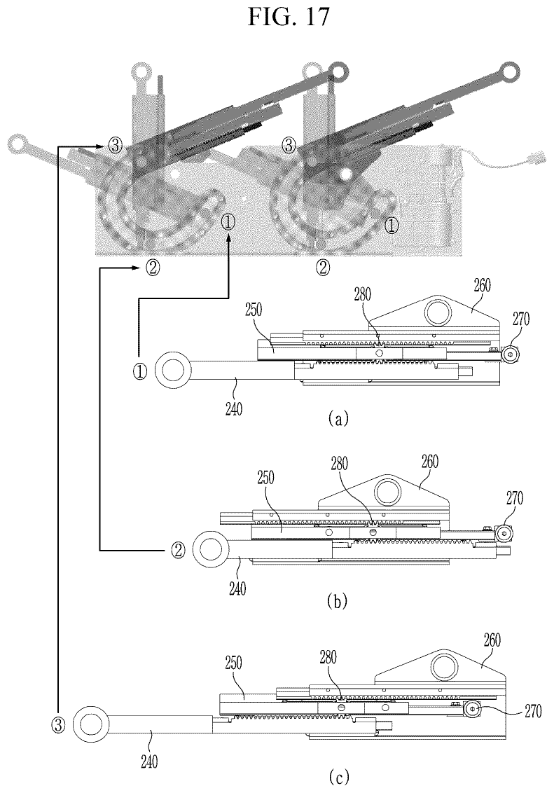

FIG. 17 is a diagram illustrating a length change according to a position of the guide bearing of the variable arm assembly of the door open-close device for the vehicle according to an embodiment of the present disclosure.

Referring to FIG. 17, when the door 10 starts to be opened (\textcircled{2}) from a closed state (\textcircled{1}), the first arm pulley gear 220 rotates and the first rotation arm 260 starts to turn. In addition, the first hook arm 230 and the first guide bearing 270 coupled to the first arm pulley gear 220 starts to turn. The first guide bearing 270 moves along the first guide slit 22, and the first slide arm 250 connected to the first guide bearing 270 turns and linearly moves with respect to the first rotation arm 260. The first slide arm 250 and the first rotation arm 260 may be relatively moved by engagement of the first pinion gear 280 and the first rotation arm rack gear 265.

As the door 10 is opened, the first slide arm 250 linearly moves, and accordingly, the first rack gear arm 240 linearly moves by engagement of the first pinion gear 280 and a rack gear of the rack gear arm 240.

Until the first rotation arm 260, the first slide arm 250, and the first rack gear arm 240 of the first variable arm assembly 200 are disposed to extend in a direction perpendicular to the vehicle body 1, the first guide slit 22 is withdrawn toward the inside of the vehicle body 1, and according to a curved shape, the first slide arm 250 and the first rack gear arm 240 may linearly move toward the inside of the vehicle body 1. Accordingly, the entire length of the first slide arm 250 and the first rack gear arm 240 may be minimized, and an amount of protrusion of the door 10 to the outside of the vehicle body 1 may be minimized.

Thereafter, until the door 10 is completely opened \textcircled{3}, the first rotation arm 260 continues to turn, the first guide bearing 270 moves along the first guide slit 22, the first guide slit 22 moves forward to the outside of the vehicle body 1, and according to the curved shape, the first slide arm 250 and the first rack gear arm 240 may linearly move toward the outside of the vehicle body 1. Accordingly, the entire length of the first slide arm 250 and the first rack gear arm 240 may be maximized.

The second guide bearing 370, the second rotation arm 360, the second slide arm 350, and the second rack gear arm 340 of the second variable arm assembly 300 interact with the movement of the first variable arm assembly 200 described above and move together, and thus, during a process of opening the door 10, the door bracket 30 and the door 10 may be maintained in positions parallel to the vehicle body 1, and the amount of protrusion of the door 10 to the outside of the vehicle body 1 may be maintained constant.

The process of changing from a complete opening state to a complete closing state of the door 10 may be a reverse order of the process of FIG. 17.

As described above, according to an embodiment of the present disclosure, the variable door arm structure is applied in the counter sliding door structure of the vehicle without a B-pillar, and thus, the door rotation radius may minimized, thereby minimizing the amount of protrusion toward the outside of the vehicle body of the door when the door is opened.

In addition, a center rail structure is removed, and thus, the door opening width may be maximized, and cost reduction, assembly, and maintenance may be improved due to the simplification of the structure which allows more than two or more swing and sliding trajectories to be implemented in a single module.

Although preferred embodiments of the present disclosure have been described above, the present disclosure is not limited to the above embodiments, the present disclosure includes all modifications within the range easily changed and recognized as being equivalent by those of ordinary skill in the art to which the present disclosure pertains from the embodiments of the present disclosure.

### DESCRIPTION OF SYMBOLS

| | |
|---|---|
| 1000: door open-close | 1: vehicle body |
| device for vehicle | |
| 10: door | 20: base plate |
| 22: first guide slit | 24: second guide slit |
| 30: door bracket | 100: variable arm motor |
| 110: variable arm motor gear | 200: first variable arm assembly |
| 210: drive gear | 220: first arm pulley gear |
| 230: first hook arm | 240: first rack gear arm |
| 250: first slide arm | 260: first rotation arm |
| 265: first rotation arm rack gear | 270: first guide bearing |
| 280: first pinion gear | 300: second variable arm assembly |
| 310: timing belt | 320: second arm pulley gear |
| 330: second hook arm | 340: second rack gear arm |
| 350: second slide arm | 360: second rotation arm |
| 370: second guide bearing | 380: second pinion gear |

What is claimed is:

1. A door open-close device configured to open and close a door opening portion of a vehicle by sliding and popping up a door disposed in a vehicle body, the door open-close device comprising:
a variable arm motor fixedly disposed on a side of the vehicle body and configured to provide a driving power to operate the door;
a first variable arm assembly having a first side hingedly coupled to the variable arm motor and a second side hingedly coupled to the side of the door and configured to transmit a rotational force to the door by receiving the driving power of the variable arm motor; and
a second variable arm assembly disposed to be parallel to the first variable arm assembly in a longitudinal direction of the vehicle body, and having a first side hingedly coupled to the side of the vehicle body and a second side hingedly coupled to the side of the door, configured to interact with a pivotal rotation of the first variable arm assembly, and transmit the rotational force to the door.

2. The door open-close device of claim 1,
wherein each of the first variable arm assembly and the second variable arm assembly includes a slide arm hingedly connecting the vehicle body and the door, and
wherein the slide arm is telescopically extendable between the vehicle body and the door.

3. The door open-close device of claim 1,
wherein the slide arm includes a first slide arm, and
wherein the first variable arm assembly includes:
a drive gear engaged with a variable arm motor gear disposed in a rotation shaft of the variable arm motor and rotated;
a first arm pulley gear engaged with the drive gear and rotated;
a first hook arm coupled to a central axis of the first arm pulley gear and rotated together with the first arm pulley gear;
a first guide bearing disposed in an end portion of the first hook arm, configured to guide a pivotal rotation of the first hook arm, and roll and move to limit a rotation angle of the first arm pulley gear;
a first rotation arm hingedly connected to the vehicle body and connected to a central axis of the first arm pulley gear and rotated together with a rotation of the first arm pulley gear;
the first slide arm having one end connected to the first guide bearing so that the first guide bearing rotates, and disposed inside the first rotation arm to linearly move in a longitudinal direction of the first rotation arm; and
a first rack gear arm gear-engaged to the first slide arm, configured to linearly move together with the first slide arm according to a linear movement of the first slide arm, and having one end hingedly connected to the side of the door.

4. The door open-close device of claim 3, wherein the first guide bearing is disposed in a slot formed in a lower portion of the end portion of the first hook arm.

5. The door open-close device of claim 4,
wherein a first pinion gear is disposed in a center of the first slide arm,
wherein a first rotation arm rack gear engaged with the first pinion gear in a first side of the first pinion gear is disposed in the first rotation arm, and
wherein the first pinion gear is configured to rotate according to a rotation of the first rotation arm and the first slide arm is configured to linearly move.

6. The door open-close device of claim 5, wherein:
a rack gear engaged with a second side of the first pinion gear is disposed in a center of the first rack gear arm, and
based on that the first pinion gear rotates according to a linear movement of the first slide arm, the first rack gear arm is configured to linearly move.

7. The door open-close device of claim 3,
wherein the slide arm includes a second slide arm, and
wherein the second variable arm assembly includes:
a second arm pulley gear engaged to the first arm pulley gear by a timing belt and configured to interact with and be rotated together with the first arm pulley gear;
a second hook arm coupled to a central axis of the second arm pulley gear and rotated together with the second arm pulley gear;
a second guide bearing disposed in an end portion of the second hook arm, configured to guide a pivotal rotation of the second hook arm, and roll and move to limit a rotation angle of the second arm pulley gear;
a second rotation arm connected to the central axis of the second arm pulley gear and rotated together with a rotation of the second arm pulley gear;
the second slide arm having one end connected to the second guide bearing, and disposed inside the second rotation arm to linearly move in a longitudinal direction of the second rotation arm; and
a second rack gear arm gear-engaged to the second slide arm, configured to linearly move together according to a linear movement of the second slide arm, and having one end hingedly connected to the side of the door.

8. The door open-close device of claim 7, wherein the second guide bearing is disposed in a slot formed in a lower portion of the end portion of the second hook arm.

9. The door open-close device of claim 8,
wherein a second pinion gear is disposed in a center of the second slide arm,
wherein a second rotation arm rack gear engaged with the second pinion gear in a first side of the second pinion gear is disposed in the second rotation arm, and
wherein the second pinion gear is configured to rotate according to a rotation of the second rotation arm and the second slide arm is configured to linearly move.

10. The door open-close device of claim 9, wherein:
a rack gear engaged with a second side of the second pinion gear is disposed in a center of the second rack gear arm, and
based on that the second pinion gear rotates according to a linear movement of the second slide arm, the second rack gear arm is configured to linearly move.

11. The door open-close device of claim 7, wherein a base plate is disposed on the side of the vehicle body, in which the variable arm motor is fixedly disposed, and to which one ends of the first variable arm assembly and the second variable arm assembly are hingedly coupled.

12. The door open-close device of claim 11,
wherein a first guide slit and a second guide slit are formed in the base plate,
wherein the first guide slit in which the first guide bearing is inserted and rotated, is configured to provide a path varying relative lengths of the first rotation arm, the first slide arm, and the first rack gear arm, and
wherein the second guide slit in which the second guide bearing is inserted and rotated is configured to provide a path varying a relative length of the second rotation arm, the second slide arm, and the second rack gear arm

13. The door open-close device of claim 12, wherein the first guide slit and the second guide slit are formed in a convex and symmetrical shape toward the side of the door.

14. The door open-close device of claim 13, wherein inside the door, a door bracket is disposed to hingedly couple one end of the first rack gear arm to one end of the second rack gear arm and connect the first variable arm assembly and the second variable arm assembly to the door.

15. The door open-close device of claim 7, wherein:
when the door starts to be opened,
the variable arm motor is driven to allow the first side of the first variable arm assembly to rotate, and
lengths of the first variable arm assembly and the second variable arm assembly are changed to be shortened.

16. The door open-close device of claim 15, wherein in a state in which the door protrudes to a maximum with respect to the vehicle body while the door is opened, the lengths of the first variable arm assembly and the second variable arm assembly are changed to be a minimum.

17. The door open-close device of claim 16, wherein until the door is completely opened in the state in which the door protrudes to the maximum with respect to the vehicle body, the lengths of the first variable arm assembly and the second variable arm assembly are increased and changed to be the maximum.

18. The door open-close device of claim 17, wherein the variable arm motor is set to stop driving based on that the door is completely opened.

19. The door open-close device of claim 18, wherein the variable arm motor has a preset number of rotations to adjust a movement range of each of the first variable arm assembly and the second variable arm assembly and an amount of opening of the door according to the number of rotations.

20. A vehicle comprising the door open-close device of claim 1.
